(19) United States
(12) Patent Application Publication
(10) Pub. No.: US 2020/0051484 A1
(43) Pub. Date: Feb. 13, 2020

(54) BACKLIGHT DEVICE AND DISPLAY DEVICE PROVIDED WITH SAME

(71) Applicant: SHARP KABUSHIKI KAISHA, Sakai City (JP)

(72) Inventor: MASAFUMI YASHIKI, Osaka (JP)

(21) Appl. No.: 16/511,459

(22) Filed: Jul. 15, 2019

Related U.S. Application Data
(60) Provisional application No. 62/716,495, filed on Aug. 9, 2018.

(51) Int. Cl. G09G 3/20; G09G 3/34

(52) U.S. Cl. CPC G09G 3/2018; G09G 3/3406; G09G 2350/00; G09G 2320/064; G09G 2320/0247

(57) ABSTRACT

An LED data holding unit that holds turn-on control data for controlling the luminance of each LED included in a backlight device is provided in an LED drive circuit. The LED data holding unit is implemented by, for example, registers. When the LED drive circuit drives the LEDs, the LED drive circuit switches a read destination of the turn-on control data from the LED data holding unit based on a turn-on switching signal. Turn-on control data for each LED is read from the LED data holding unit a ty of times during each frame period.

### CROSS REFERENCE TO RELATED APPLICATIONS

This application claims priority no U.S. Provisional Patent Application. No. 62/716,495, entitled “BACKLIGHT DEVICE AND DISPLAY DEVICE PROVIDED WITH SAME”, filed on Aug. 9, 2018, the content of which is incorporated herein by reference.

### BACKGROUND OF THE INVENTION

### 1. Field of the Invention

The following disclosure relates to a backlight device including LEDs as light sources, and a display device including the backlight device.

### 2. Description of Related Art

A transmissive liquid crystal display device requires a backlight device that irradiates a display portion (liquid crystal panel) with light from the back of the display portion, to display an image. For the light sources of the backlight device, cold cathode fluorescent lamps called CCFLs are conventionally often adopted. However, in recent years, adoption of light-emitting diodes (LEDs) has increased in terms of their low power consumption, easiness of luminance control, etc.

Regarding a liquid crystal display device such as that described above, in order to achieve a reduction in power consumption, there is developed a technique called “local dimming” in which a screen is logically divided into a plurality of areas and the luminances (light emission intensities) of LEDs are controlled on an area-by-area basis. According to the local dimming, the luminance of each LED is determined based on, for example, the maximum value or average value of input gradation values of pixels included in a corresponding area. In this manner, each LED emits light at a luminance determined based on an input image in a corresponding area.

Now, LED dimming scheme will be described. The dimming schemes mainly include an analog dimming scheme and a PWM dimming scheme. In the analog dimming scheme, as shown in FIG. 18, the luminance of an LED is control led by changing the magnitude of a current flowing through the LED, with the LED turn-on time being fixed. In the PWM dimming scheme, as shown in FIG. 19, the luminance of an LED is controlled by changing the LED turn-on time, with the magnitude of a current flowing through the LED being fixed.

As described above, the dimming schemes include the analog dimming scheme and the PWM dimming scheme. According to the analog dimming scheme, since a relationship between a current flowing through an LED and the luminance of the LED is nonlinear, it is difficult to implement such control that allows obtaining a desired luminance. In addition, the analog dimming scheme also has a problem that a shift in current value causes a change in chromaticity. Hence, in recent years, adoption of the PWM dimming scheme has become the mainstream.

In addition, an interface (an interface for transfer of data for controlling the luminance of LEDs) of an LED drive circuit (LED driver IC) also has two schemes. A first scheme is, as schematically shown in FIG. 20, a scheme in which a PWM signal is inputted to an LED drive circuit. The PWM signal inputted to the LED drive circuit is a low-voltage control signal. In the first scheme, the LED drive circuit outputs an LED drive signal, based on the low-voltage control signal. According to the first scheme, since the input and the output have a one-to-one relationship, when the number of LED control channels increases, the number of terminals that need to be provided in the LED drive circuit also increases. Hence, the first scheme is not suitable for a case in which the number of control channels is remarkably large. A second scheme is, as schematically shown in FIG. 21, a scheme in which digital data is inputted so an LED drive circuit. In the second scheme, the LED drive circuit outputs an LED drive signal, based on turn-on control data inputted as the digital data. The second scheme requires protocol control, and since there is no standard protocol for the scheme, a control protocol also needs to be changed depending on a change of an IC serving as the LED drive circuit.

FIG. 22 is a schematic diagram of a direct-type backlight device that performs local dimming. The backlight device includes an LED drive circuit 910; and an illuminating unit 920 in which multiple LEDs serving as light sources are mounted on a substrate. The substrate that constitutes the illuminating unit 920 is logically divided into a plurality of areas (in FIG. 22, 16 (four vertical×four horizontal) areas), and an LED unit 922 including one or more LEDs is provided in each area.

Note that in the present specification it is assumed that each LED unit includes one LED. Therefore, in the example shown in FIG. 22, the illuminating unit 920 includes 16 LEDs 922.

Conventionally, the LEDs 922 in the illuminating unit 920 are individually driven. That is, as shown in FIG. 23, channels for LED drive signals are provided in the LED drive circuit 910 for the respective areas, and control signal wiring lines are disposed on the substrate that constitutes the illuminating unit 920 for the respective areas. In this configuration, when the PWM dimming scheme is adopted, each LED 922 can be turned on for 100% of a period at the maximum in each frame period.

Meanwhile, in recent years, development of microscopic LEDs (such as LEDs called “mini-LEDs” and LEDs called “micro-LEDs”) as compared to the conventional LEDs has become more active. It is expected that a display region of a display device is divided into multiple areas by adopting a backlight device that performs local dimming using such microscopic LEDs. Regarding this, for example, when 2048 areas are provided, 128 LED drive circuits (LED driver ICs) each including 16 channels for LED drive signals, are required to individually drive LEDs, and thus, an area where the LED drive circuits are mounted remarkably increases. In addition, the number of wiring lines also becomes enormous. Therefore, in a case in which the display region is divided into multiple areas, it is difficult to drive the LEDs individually. Hence, there is proposed time division driving (passive driving) in which LEDs are driven, for example, on a row-by-row basis like matrix driving of a liquid crystal display device.

Time-division driving of LEDs will be described with reference to FIG. 24. Time-division driving of LEDs is performed with wiring lines provided as schematically shown in FIG. 24. According to the configuration shown in FIG. 24, the LEDs 922 are driven on a row-by-row basis by switching of a switch 930. Therefore, in the time-division driving, one frame period is divided into a plurality of subframe periods, and during each subframe period LEDs 922 in a corresponding row are turned on. In the case of the example shown in FIG. 24, one frame period is divided into four subframe periods T91 to T94 as shown in FIG. 25, and the LEDs are turned on row by row. Note that in FIG. 25, a period during which the LEDs can be turned on is represented in white, and a period during which the LEDs are turned off is represented in black (the same also applies to FIG. 26).

However, when the LEDs are driven as shown in FIG. 25, each LED blinks. Specifically, each LED blinks at a frequency of 60 Hz (at a cycle of 1/60 seconds). When the LEDs thus blink at a frequency of 60 Hz, flicker is visually recognized.

Note that a backlight device that drives LEDs on a row-by-row basis is described in WO 2007/017797 A. Note also that Japanese Laid-Open Patent Publication No. 2011-13558 describes controlling of an LED turn-on cycle to optimize moving-image blur and flicker, though it is not ah invention regarding time-division driving of LEDs.

As a technique for suppressing the occurrence of flicker in the above-described time-division driving, turning on each LED a plurality of times during each frame (i.e., increasing a turn-on frequency of each LED) is considered. For example, in a backlight device having the configuration shown in FIG. 24, turning on each LED four times during each frame period as shown in FIG. 26 is considered. In this case, however, turn-on control data which is data for controlling the luminance of each LED needs to be transferred four times from an external source to the LED drive circuit 910. Therefore, a high speed interface is required for transfer of the turn-on control data, but when the high-speed interface is used, there are disadvantages such as an increase in power consumption and an increase in the number of wiring lines.

### SUMMARY OF THE INVENTION

It is therefore desired to implement a backlight device that can perform time-division driving of LEDs so as not to cause flicker, without using a high-speed interface.
(1) Backlight devices according to several embodiments of the present invention are each a backlight device including LEDs as light sources, the backlight device including:

a plurality of LED units divided into a plurality of groups, each of the plurality of LED units including; one or more LEDs; and

an LED drive circuit configured to time-divisionally drive the LEDs included in the plurality of LED units on a group-by-group basis, wherein

the LED drive circuit:
includes a turn-on control data holding unit configured to hold turn-on control data, the turn-on control data being data transmitted from an external source to control luminances of the one or more LEDs included in each of the plurality of LED units; and
drives a drive-target LED based on turn-on control data read from the turn-on control data holding unit based on a predetermined turn-on switching signal,
the one or more LEDs included in each of the plurality of LED units are driven N times (N is an integer greater than or equal to two) during one frame period, and

turn-on control data corresponding to the one or more LEDs included in each of the plurality of LED units is read by the LED drive circuit N times during one frame period from the turn-on control data holding unit.

According to such a configuration, time-division driving of LEDs is performed such that a plurality of LEDs constituting a backlight device are turned on on a group-by-group basis and each LED is turned on twice or more during each frame period. Under such a presumption, in an LED drive circuit that drives the LEDs, there is provided a turn-on control data holding unit that holds turn-on control data for controlling the luminance of each LED. Read destination of the turn-on control data used to drive the LEDs is switched based on a turn-on switching signal. Each LED can be turned on twice or more during each frame period by repeatedly using the turn-on control data held in the turn-on control data holding unit in this manner, and thus, there is no need to repeatedly transfer the same turn-on control data to the LED drive circuit from an external source. Therefore, without using a high-speed interface, turn-on control data can be transferred to perform desired time-division driving. In addition, by turning on each LED at a high frequency, the occurrence of flicker is prevented. By the above, a backlight device that can perform time-division driving of LEDs so as not to cause flicker can be implemented without using a high-speed. interface.
(2) Moreover, backlight devices according to several embodiments of the present invention are each a backlight device including the configuration of above (1), wherein when a length of one frame period is FT and a number of the groups is GN, turn-on control data read from the turn-on control data holding unit based on the turn-on switching signal is switched every time T calculated by a following equation:

T=FT/(GN×N).
(3) Moreover, backlight devices according to several embodiments of the present invention are each a backlight device including the configuration of above (2), wherein the LED drive circuit includes an operating condition information holding unit configured to hold information on the length of one frame period, information on a number of times the one or more LEDs included in each of the plurality of LED units are driven during one frame period, and information on the number of the groups.
(4) Moreover, backlight devices according to several embodiments of the present invention are each a backlight device including the configuration of any one of above (1) to (3), wherein the LED drive circuit includes a timer configured to generate the turn-on switching signal by measuring time from a driving start time point of LEDs included in each group.
(5) Moreover, backlight devices according to several embodiments of the present invention are each a backlight device including the configuration of any one of above (1) to (3), wherein the LED drive circuit includes a turn-on switching signal generating unit configured to generate the turn-on switching signal based on a synchronizing signal transmitted from an external source.
(6) Moreover, backlight devices according to several embodiments of the present invention are each a backlight device including the configuration of above (5), wherein

the synchronizing signal is a horizontal synchronizing signal, and

the turn-on switching signal generating unit generates the turn-on switching signal by counting a number of times a pulse of the horizontal synchronizing signal is generated.
(7) Moreover, backlight devices according to several embodiments of the present invention are each a backlight device including the configuration of above (5), wherein

the synchronizing signal is a vertical synchronizing signal, and

the turn-on switching signal generating unit generates the turn-on switching signal by multiplying a frequency of the vertical synchronizing signal.
(8) Moreover, backlight devices according to several embodiments of the present invention are each a backlight device including the configuration of any one of above (1) to (3), wherein the turn-on switching signal is provided to the LED drive circuit from an external source.
(9) Moreover, backlight devices according to several embodiments of the present invention are each a backlight device including the configuration of any one of above (1) to (8), wherein the turn-on control data holding unit is a register.
(10) Moreover, backlight devices according to several embodiments of the present invention are each a backlight device including the configuration of any one of above (1) to (8), wherein the turn-on control data holding unit is a memory.
(11) Moreover, display devices according to several embodiments of the present invention are each a display device including:

a display panel including a display portion configured to display an image; and

a backlight device including the configuration of any one of above (1) to (10), the backlight device being provided on a back of the display panel such that the display portion is irradiated with light.

These and other objects, features, aspects, and effects of the present invention will be made more clear from the following detailed description of the present invention with reference to the accompanying drawings.

### BRIEF DESCRIPTION OF THE DRAWINGS

FIG. 1 is a block diagram showing an overall configuration of a liquid crystal display device according to a first embodiment.

FIG. 2 is a diagram for describing a configuration of a display portion in the first embodiment.

FIG. 3 is a block diagram for describing a schematic configuration of a backlight device in the first embodiment.

FIG. 4 is a block diagram showing a functional configuration of an LED drive circuit in the first embodiment.

FIG. 5 is a diagram for describing reference characters for identifying LEDs in the first embodiment.

FIG. 6 is a diagram schematically snowing configurations of an external setting turn-on control data holding register group and an internal reading turn-on control data holding register group in the first embodiment.

FIG. 7 is a diagram schematically showing a configuration of a conventional register group for holding turn-on control data.

FIG. 8 is a diagram schematically showing a configuration of an operating condition setting register in the first embodiment.

FIG. 9 is a diagram schematically showing; a configuration of a conventional register corresponding to the operating condition setting register.

FIG. 10 is a circuit diagram for describing a PWM/constant-current generating unit in the first embodiment.

FIG. 11 is a signal waveform diagram for describing the operation of the LED drive circuit in the first embodiment.

FIG. 12 is a diagram for describing switching of read destination of the turn-on control data in the first embodiment.

FIG. 13 is a block diagram showing an overall configuration of a liquid crystal display device according to a second embodiment.

FIG. 14 is a block diagram showing a functional configuration of an LED drive circuit in the second embodiment.

FIG. 15 is a signal waveform diagram for describing generation of a turn-on switching signal in a variant of the second embodiment.

FIG. 16 is a block diagram showing an overall configuration of a liquid crystal display device according to a third embodiment.

FIG. 17 is a block diagram showing a functional configuration of an LED drive circuit in the third embodiment.

FIG. 18 is a diagram for describing an analog dimming scheme regarding a conventional example.

FIG. 19 is a diagram for describing a PWM dimming scheme regarding the conventional example.

FIG. 20 is a diagram for describing a first scheme for an interface of an LED &rive circuit regarding the conventional example.

FIG. 21 is a diagram for describing a second scheme for the interface of the LED drive circuit regarding the conventional example.

FIG. 22 is a schematic diagram of a direct-type backlight device that performs local dimming regarding the conventional example.

FIG. 23 is a diagram schematically showing a state of wiring lines for a case of individually driving LEDs regarding the conventional example.

FIG. 24 is a diagram schematically showing a state of wiring lines for a case of performing time-division driving (passive driving) of the LEDs regarding the conventional example.

FIG. 25 is a diagram for describing; time-division driving of the LEDs (a case in which each LED is turned on only once during each frame period) regarding the conventional example.

FIG. 26 is a diagram for describing time-division driving of the LEDs (a case in which each LED is turned on four times during each frame period) regarding the conventional example.

### DETAILED DESCRIPTION OF PREFERRED EMBODIMENTS

Embodiments will be described below with reference to the accompanying drawings.

### 1. First Embodiment

### <1.1 Overall Configuration>

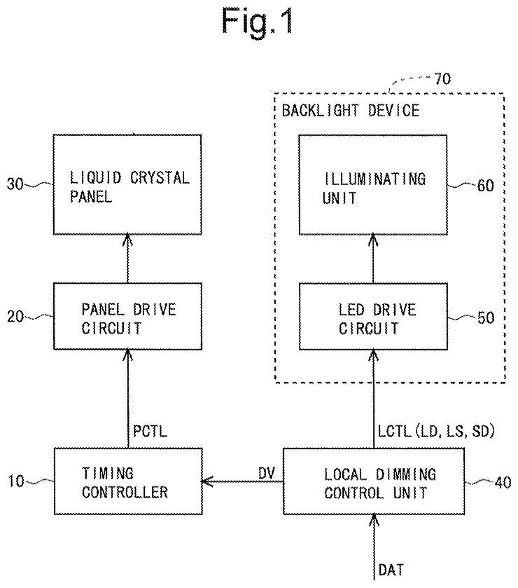

FIG. 1 is a block diagram showing an overall configuration of a liquid crystal display device according to a first embodiment. The liquid crystal display device includes a timing controller 10, a panel drive circuit 20, a liquid crystal panel 30, a local dimming control unit 40, and a backlight device 70. The liquid crystal panel 30 is formed by two glass substrates facing each other, and includes a display portion that displays an image. The backlight device 70 is provided on the back of the liquid crystal panel 30. The backlight device 70 includes an LED drive circuit (LED driver IC) 50; and an illuminating unit 60 in which a plurality of LEDs serving as light sources are mounted on a substrate Note that the PWM dimming scheme is adopted as an LED dimming scheme.

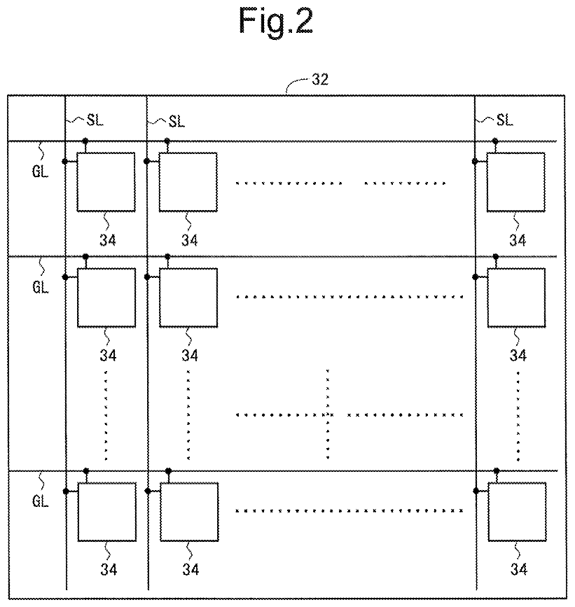

In the display portion 32 in the liquid crystal panel 30, as shown in FIG. 2, a plurality of gate bus lines GL and a plurality of source bus lines SL are disposed. Pixel portions 34 are provided at the respective intersections of the plurality of gate bus lines GL and the plurality of source bus lines SL. That is, the display portion 32 includes a plurality of pixel portions 34. The plurality of pixel portions 34 are arranged in a matrix form, forming a pixel matrix. Each pixel portion 34 includes a pixel capacitance.

The operation of the components shown in FIG. 1 will be described. The local dimming control unit 40 receives image data DAT transmitted from an external source, and outputs LED control signals LCTL for controlling the operation of the LED drive circuit 50 so as to perform the above-described local dimming (a process of controlling the luminances of the LEDs on an area-by-area basis). In the present embodiment, the LED control signals LCTL include turn-on control data LD, a latch signal LS, and operation setting data SD. Furthermore, the local dimming control unit 40 performs a correction process on the image data DAT based on the turn-on states of the LEDs, and outputs corrected image data DV to the timing controller 10. Note that in the correction process, liquid crystal data which is one of panel control signals PCTL is corrected so as to obtain the same luminance as that represented by input image data (image data DAT). Specifically, when an LED is darkened, liquid crystal data is corrected to increase transmittance, and when an LED is lightened, liquid crystal data is corrected to reduce transmittance.

The timing controller 10 receives the above-described corrected image data DV, and outputs panel control signals PCTL to the panel drive circuit 20.

The panel drive circuit 20 drives the liquid crystal panel 30 based on the panel control signals PCTL transmitted from the timing controller 10. Specifically, the panel drive circuit 20 includes a gate driver that drives the gate bus lines GL; and a source driver that drives the source bus lines SL. By the gate driver driving the gate bus lines GL and the source driver driving the source bus lines SL, a voltage determined based on a target display image is written to the pixel capacitance in each pixel portion 34. Note that it is assumed that the frame rate is 60 Hz.

The LED drive circuit 50 drives each LED based on the LED control signals LCTL transmitted from the local dimming control unit 40, such that the LEDs in the illuminating unit 60 emit light at their desired luminances. Note that a detailed description of the LED drive circuit 50 will be made later.

The illuminating unit 60 includes the LEDs provided for the respective areas, and each LED emits light at a desired luminance based on the operation of the LED drive circuit 50. In this manner, the illuminating unit 60 irradiates the display portion 32 with light from the back of the display portion 32.

In the above-described manner, the illuminating unit 60 in the backlight device 70 irradiates the display portion 32 with light from the back of the display portion 32, with a voltage, which is determined based on a target display image, written to the pixel capacitance in each pixel portion 34 provided in the display portion 32 of the liquid crystal panel 30, by which a desired image is displayed on the da splay portion 32.

### <1.2 Backlight Device>

### <1.2.1 Schematic Configuration>

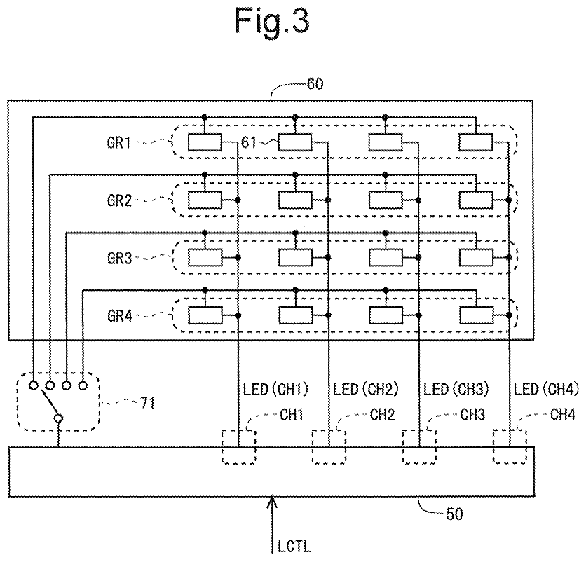

FIG. 3 is a block diagram for describing a schematic configuration of the bac-Alight device 70. As described above, the backlight device 70 includes the LED drive circuit 50 and the illuminating unit 60. In addition, the backlight device 70 includes a switch 71 for performing time-division driving of the LEDs. In the present embodiment, for convenience of description, it is assumed that the substrate (LED substrate) that constitutes the illuminating unit 60 is logically divided into 16 (four vertical×four horizontal) areas. Note, however, that in general, there are 1000 areas or more.

In the present embodiment, in the illuminating unit 60 there are provided LEDs 61 for the respective areas. That is, the illuminating unit 60 has 16 LEDs 61 provided therein. The 16 LEDs 61 are divided into four groups GR1 to GR4 such that one group is formed by four LEDs 61 corresponding to each row. By performing switching of the switch 71, the LEDs 61 are driven on a row-by-row basis Note that four LEDs 61 forming each group are connected to each other at their anodes or cathodes.

Since one group is formed by four LEDs 61, four channels CH1 to CH4 are provided in the LED drive circuit 50, as channels for LED drive signals. Note that in FIG. 3 LED drive signals for the respective four channels CH1 to CH4 are provided with reference characters LED (CH1) to LED CH4).(

### <1.2.2 LED Drive Circuit>

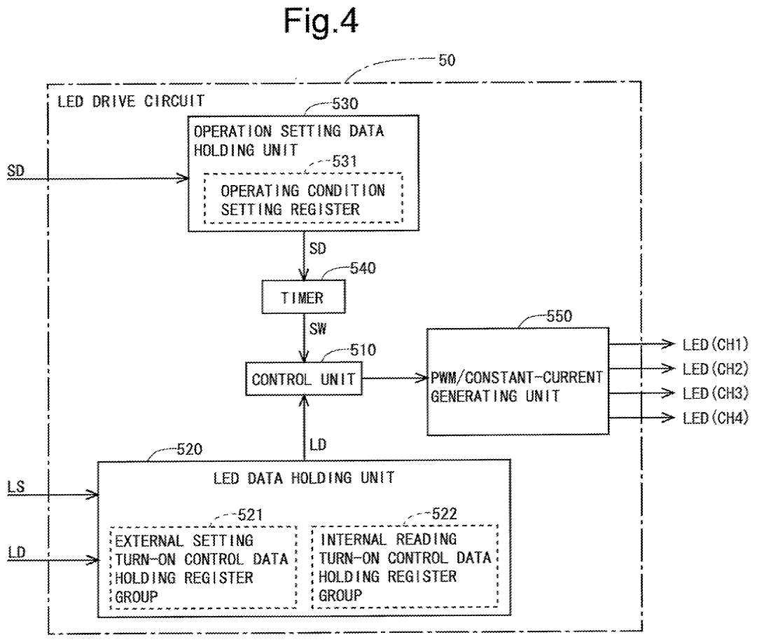

FIG. 4 is a block diagram showing a functional configuration of the LED drive circuit 50 in the present embodiment. The LED drive circuit 50 includes, as shown in FIG. 4, a control unit 510, an LED data holding unit 520, an operation setting data holding unit 530, a timer 540, and a PWM/constant-current generating unit 550. Note that in the present embodiment, a turn-on control data holding unit is implemented by the LED data holding unit 520, and an operating condition information holding unit is implemented by the operation setting data holding unit 530.

First, schematic operation of the LED drive circuit 50 will be described. Turn-on control data LD which is data for controlling the luminance of each LED 61 in the illuminating unit 60 is provided to the LED drive circuit 50 from an external source. The turn-on control data LD is held in the LED data holding unit 520. In addition, operation setting data SD is provided to the LED drive circuit 50 from an external source at timing such as immediately after activating the liquid crystal display device, and the operation setting data SD is held in the operation setting data holding unit 530. Meanwhile, although the LED data holding unit 520 holds pieces of turn-on control data LD corresponding to the 16 LEDs 61, the turn-on control data LD needs to be read out four by four from the LED data holding unit 520 in order to perform time-division driving of the LEDs 61 (in order to drive the LEDs 61 on a row-by-row basis) in this backlight device 70. Hence, a turn-on switching signal SW for switching read destination of the turn-on control data LD is generated by the timer 540, based on the operation setting data SD held in the operation setting data holding unit 530. Then, based on the turn-on switching signal SW generated by the timer 540, the control unit 510 reads pieces of turn-on control data LD for drive-target LEDs 61 from the LED data holding unit 520, and controls the operation of the PWM/constant-current generating unit 550 based on the read pieces of turn-on control data LD. By this, the PWM/constant-current generating unit 550 outputs LED drive signals LED (CH1) to LED (CH4) such that each LED 61 is turned on at a luminance determined based on the turn-on control data LD.

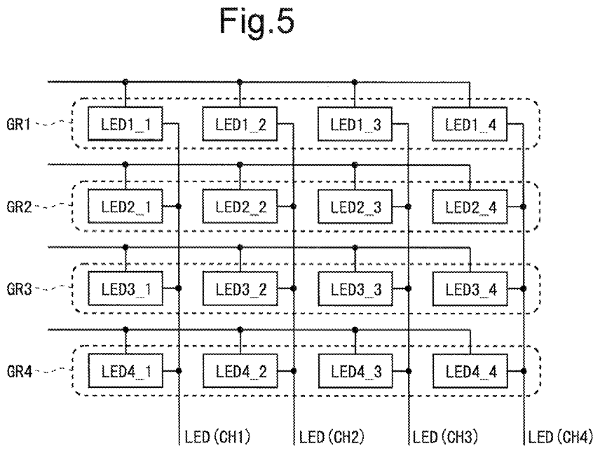

The configuration and operation of the LED drive circuit 50 will be described in detail below. Note that for the configuration shown in FIG. 3, in the following description, each LED is identified by a reference character shown in FIG. 5. For example, an LED2_3 indicates an LED that is included in the group GR2 and corresponds to the channel CH3.

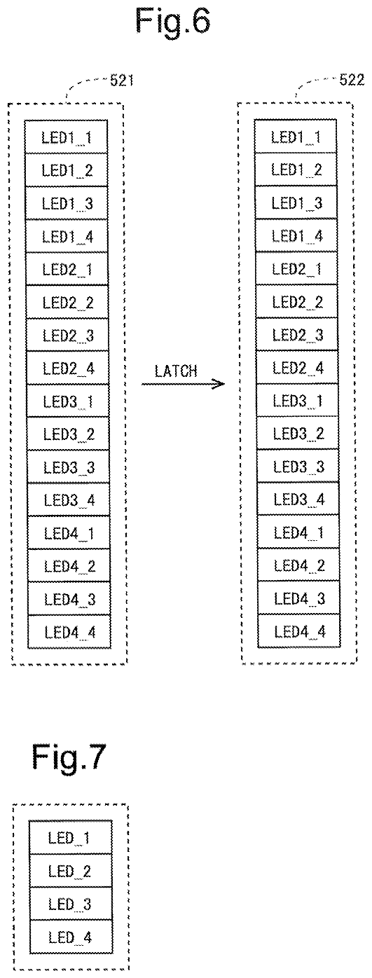

The LED data holding unit 520 includes an external setting turn-on control data holding register group 521 and an internal reading turn-on control data holding register group 522. Each register constituting the external setting turn-on control data holding register group 521 or the internal reading turn-on control data holding register group 522 is a volatile register. As shown in FIG. 6, the external setting turn-on control data holding register group 521 includes 16 registers for holding pieces of turn-on control data LD for the respective LEDs 61 in the illuminating unit 60. Note that in FIG. 6 by a rectangle provided with a reference character for identifying an LED, a register that holds turn-on control data LD for the LED identified by the reference character is schematically represented. Likewise, the internal reading turn-on control data holding register group 522 also includes 16 registers for holding pieces of turn-on control data LD for the respective LEDs 61 in the illuminating unit 60. Note that in a conventional LED drive circuit, as shown in FIG. 7, registers whose number is equal to the number of LEDs included in one group (four registers when the number of channels is four) are provided as a register group for holding turn-on control data.

Turn-on control data LD is transmitted to the LED drive circuit 50 via a serial bus such as an Inter-Integrated Circuit (I2C) or a Serial Peripheral Interface (SPI). The turn-on control data LD transmitted to the LED drive circuit 50 includes address information, and the turn-on control data LD (information on the luminance of an LED) is written to a corresponding register an the external setting turn-on control data holding register group 521, based on the address information. The turn-on control data LD written to the external setting turn-on control data holding register group 521 is transferred to the internal reading turn-on control data holding register group 522, based on a latch signal LS transmitted from the local dimming control unit 40. Then, the turn-on control data LD is read by the control unit 510 from a corresponding register in the internal reading turn-on control data holding register group 522. Note that, for example, a vertical synchronizing signal may be used as the latch signal LS.

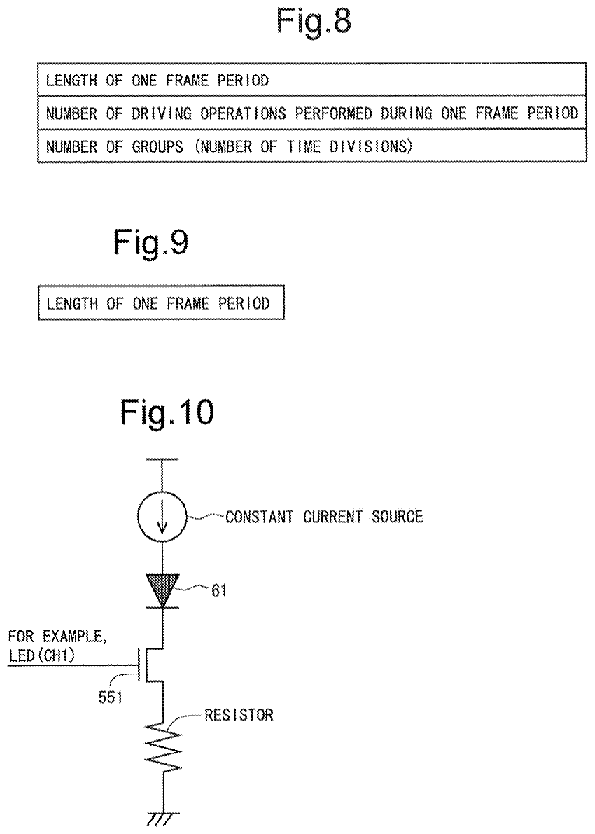

The operation setting data holding unit 530 is configured by an operating condition setting register 531. The operating condition setting register 531 is a register for holding operation setting data SD. More specifically, the operating condition setting register 531 is a volatile register for holding information on the length of one frame period; information on the number of times each LED 61 is driven during one frame period (the number of times each LED 61 repeats turn-on and turn-off during one frame period); and information on the number of time divisions for time-division driving of the LEDs, i.e., the number of the above-described groups (see FIG. 8). Note that in the conventional LED drive circuit, a register that holds only information on the length of one frame period as shown in FIG. 9 is provided as a register corresponding to the operating condition setting register 531 of the present embodiment.

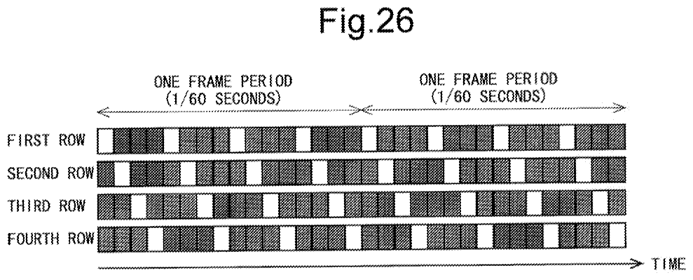

Operation setting data SD is, as with turn-on control data LD, transmitted to the LED drive circuit 50 via a serial bus such as I2C or SPI. The operation setting data SD transmitted to the LED drive circuit 50 is written to the operating condition setting register 531. In the present embodiment, information to be written to the operating condition setting register 531 is as follows. The frame rate is 60 Hz and thus the length of one frame period is 16.6 milliseconds. In the present embodiment, the LED drive circuit 50 drives each LED 61 such that each LED 61 is turned on four times during each frame period as shown in FIG. 26. That is, the number of times each LED 61 is driven during one frame period is four. The number of groups is, as described above, four.

Here, when the length of one frame period is FT, the number of times each LED 61 is driven during one frame period is N, and the number of groups is GN, the maximum time (maximum turn-on time) T during which each LED can be turned on by a single driving operation is as shown in the following equation (1):

T=FT/(GN×N) (1)

In the example of the present embodiment, the maximum turn-on time T is calculated by the following equation (2) and thus is about one millisecond.

T=16.6/(4×4) (2)

Meanwhile, each register constituting the above-described external setting turn-on control data holding register group 521 or internal reading turn-on control data holding register group 522 is, for example, eight bits. In this case, for example, the fact that the value held in a register is 255 indicates that an LED 61 corresponding to the register should be turned on at a duty ratio of 100%, and the fact that the value held in a register is 127 indicates that an LED 61 corresponding to the register should be turned on at a duty ratio of 50%. In the example of the present embodiment, a duty ratio of 100% corresponds to turning on of an LED 61 for about one millisecond, and a duty ratio of 50% corresponds to turning on of an LED 61 for about 0.5 milliseconds.

The timer 540 generates a turn-on switching signal SW, based on the maximum turn-on time T obtained in the above-described manner. More specifically, the timer 540 measures time from a driving start time point of LEDs 61 included in each group, and generates a turn-on switching signal SW such that a rising edge, for example, of the turn-on switching signal SW occurs at a point in time when the maximum turn-on time T has elapsed.

The control unit 510 reads turn-on control data LD from the internal reading turn-on control data holding register group 522 in the LED data holding unit 520 based on the turn-on switching signal SW generated in the above-described manner, and controls the operation of the PWM/constant-current generating unit 550 such that a drive-target LED 61 is driven based on the read turn-on control data LD. Note that in the present embodiment, turn-on control data LD to be read from the internal reading turn-on control data holding register group 522 in the LED data holding unit 520 based on the turn-on switching signal SW is switched every time T which is obtained by the above equation (1).

The PWM/constant-current generating unit 550 outputs LED drive signals LED (CH1) to LED (CH4) such that each LED 61 is turned on at a luminance determined based on turn-on control data LD. More specifically, the PWM/constant-current generating unit 550 generates a PWM signal that controls the on/off state of a transistor 551 such that an LED 61 (a drive-target LED 61) is turned on at a luminance determined based on turn-on control data LD and outputs the PWM signal as an LED drive signal, while maintaining a state in which a constant current can flow through the LED 61 by a configuration schematically, for example, as shown in FIG. 10.

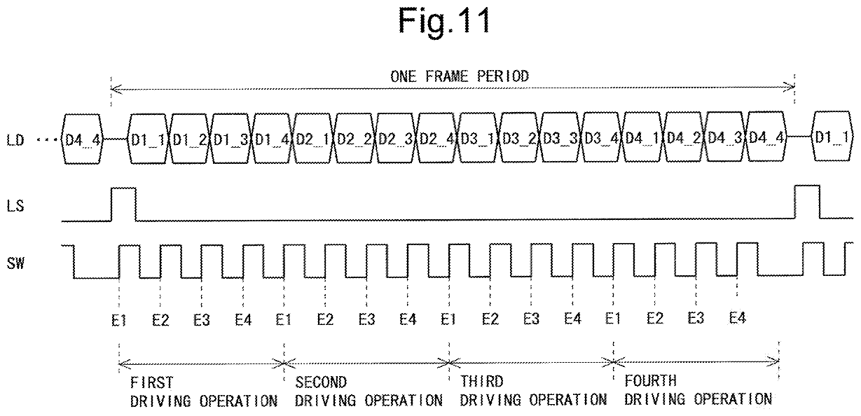

FIG. 11 is a signal waveform diagram for describing the operation of the LED drive circuit 50. Note that for FIG. 11, for example, reference character D2_3 indicates turn-on control data LID for an LED2_3 (see FIG. 5). As shown in FIG. 11, during each frame period, pieces of turn-on control data LD for the 16 LEDs 61 are inputted to the LED drive circuit 50. At that time, every time turn-on control data LD for each LED 61 is inputted, the turn-on control data LD is written to a corresponding register in the external setting turn-on control data holding register group 521. After all pieces of turn-on control data LD for the 16 LEDs 61 are written to the registers in the external setting turn-on control data holding register group 521, all pieces of turn-on control data LD held in the external setting turn-on control data holding register group 521 are transferred to the internal reading turn-on control data holding register group 522 at timing of occurrence of a rising edge of a latch signal LS.

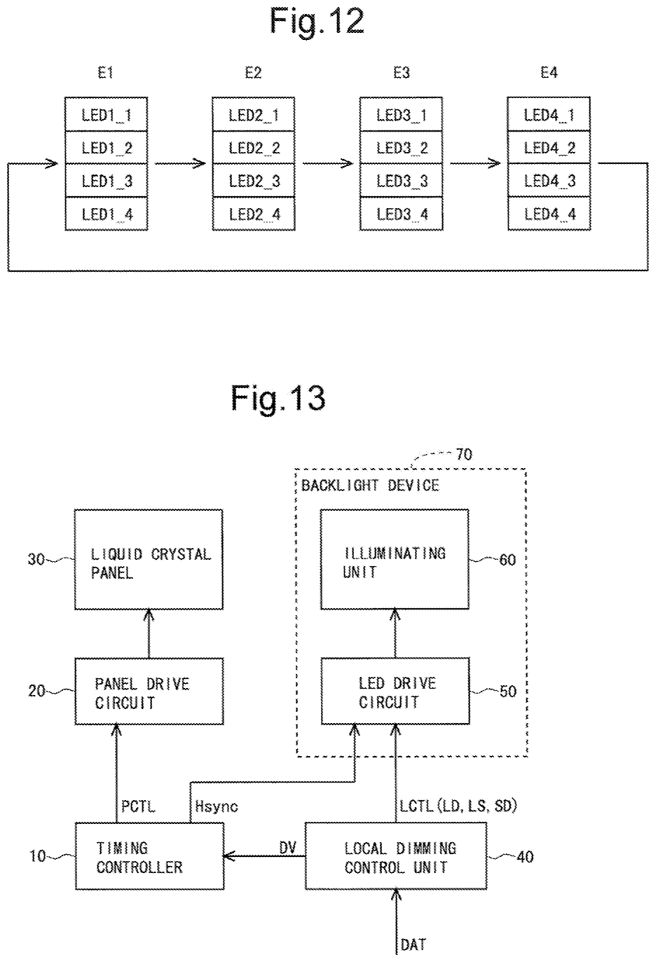

Then, with the pieces of turn-on control data LD for the 16 LEDs 61 being held in the internal reading turn-on control data holding register group 522, a rising edge of a turn-on switching signal SW occurs every ( 1/16) frame period as shown in FIG. 11. Note that timing indicated by reference character Ex (x is any of 1 to 4) in FIG. 11 is timing at which registers of read destination from the internal reading turn-on control data holding register group 522 are set to registers corresponding to LEDs 61 included in an xth row. Based on the turn-on switching signal SW having a waveform shown in FIG. 11, registers of read destination from the internal reading turn-on control data holding register group 522 change as shown in FIG. 12. Specifically, changes of read destination such as those shown in FIG. 12 are repeated four times during each frame period. By this, as shown in FIG. 26, the LEDs 61 are turned on four times during each frame period on a row-by-row basis. Note that, since the frame rate is 60 Hz as described above, the turn-on frequency of the LEDs 61 is 240 Hz.

### <1.3 Advantageous Effects>

According to the present embodiment, time-division driving of LEDs 61 is performed such that a plurality of LEDs 61 constituting the backlight device 70 are turned on on a row-by-row basis and each LED 61 is turned on four times during each frame period. Under such a presumption, in the LED drive circuit 50 that drives the LEDs 61, there are provided registers that function as the LED data holding unit 520 than holds turn-on control data LD for controlling the luminance of each LED 61. Registers of read destination of the turn-on control data LD used to drive the LEDs 61 are switched based on a turn-on switching signal SW. Each LED 61 can be turned on a plurality of times during each frame period by repeatedly using the turn-on control data LD held in the registers in this manner, and thus, there is no need to repeatedly transfer the same turn-on control data LD to the LED drive circuit 50 from an external source. Therefore, without using a high-speed interface, turn-on control data LD can be transferred to perform desired time-division driving. In addition, since each LED 61 is turned on at a frequency of 240 Hz, flicker does not occur. By the above, according to the present embodiment, a backlight device that can perform time-division driving of LEDs so as not to cause flicker can be implemented without using a high-speed interface.

### <1.4 Variant>

In the above-described first embodiment, the LED data holding unit 520 for holding turn-on control data LD which is transmitted to the LED drive circuit 50 from an external source is implemented by registers. However, the present invention is not limited thereto, and the LED data holding unit 520 can also be implemented by memories.

### 2. Second Embodiment

### <2.1 Outline and Overall Configuration>

In the above-described first embodiment, a turn-on switching signal SW for switching read destination of the turn-on control data LD is generated by the timer 540 (see FIG. 4). In contrast, in the present embodiment, a turn-on switching signal SW is generated based on a synchronizing signal. A difference from the first embodiment will be described below.

FIG. 13 is a block diagram showing an overall configuration of a liquid crystal display device according to a second embodiment. In the present embodiment, a horizontal synchronizing signal Hsync is transmitted to the LED drive circuit 50 from the timing controller 10. Other than that, the present embodiment is The same as the first embodiment. Note that the horizontal synchronizing signal Hsync may be transmitted to the LED drive circuit 50 from a component other than the timing controller 10.

### <2.2 Configuration of the LED Drive Circuit>

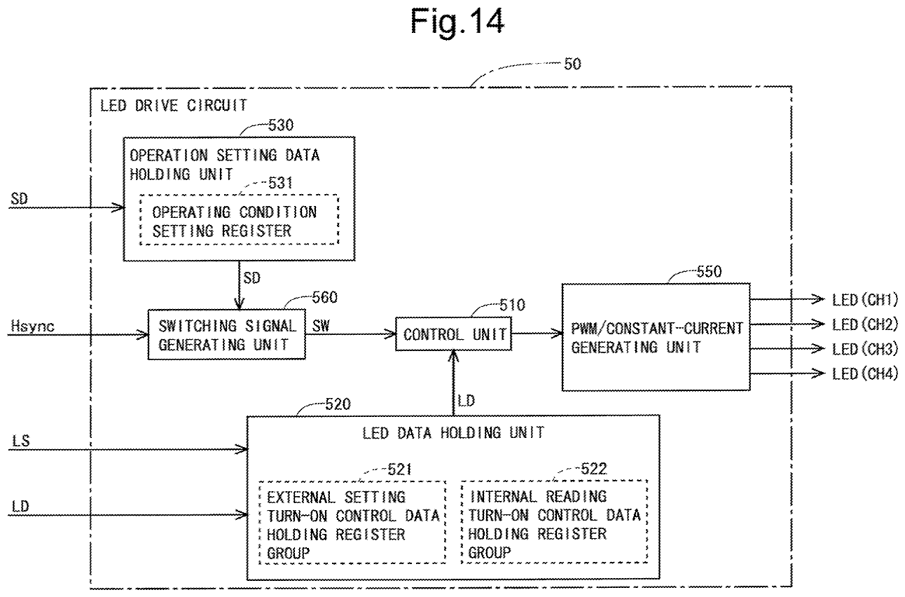

FIG. 14 s a block diagram showing afunctional configuration of the LED drive circuit 50 in the present embodiment. In the present embodiment, in the LED drive circuit 50, there is provided a switching signal generating unit 560 instead of the timer 540 of the first embodiment. The switching signal generating unit 560 generates a turn-on switching signal SW based on a horizontal synchronizing signal Hsync transmitted from the timing controller 10.

Here, as in the first embodiment, it is assumed that the LEDs 61 are divided into four groups and each LED 61 is turned on four times during each frame period. In this case, switching of registers of read destination of the turn-on control data LD needs to be performed 16 times during each frame period. Therefore, if the number of gate bus lines GL is 1080, then switching of registers of read destination of the turn-on control data LD needs to be performed every about 67 (=1080/16) horizontal scanning periods. Hence, the switching signal generating unit 560 counts the number of times a pulse of the horizontal synchronizing signal Hsync is generated, and generates a turn-on switching signal SW such that a rising edge, for example, of the turn-on switching signal SW occurs every 67th generation of the pulse. Based on the turn-on switching signal SW thus generated by the switching signal generating unit 560, as in the first embodiment, switching of registers of read destination of the turn-on control data LD used to drive the LEDs 61 is performed.

### <2.3 Advantageous Effects>

Also in the present embodiment, as in the first embodiment, a backlight device that can perform time-division driving of LEDs so as not to cause flicker can be implemented without using a high-speed interface.

### <2.4 Variant>

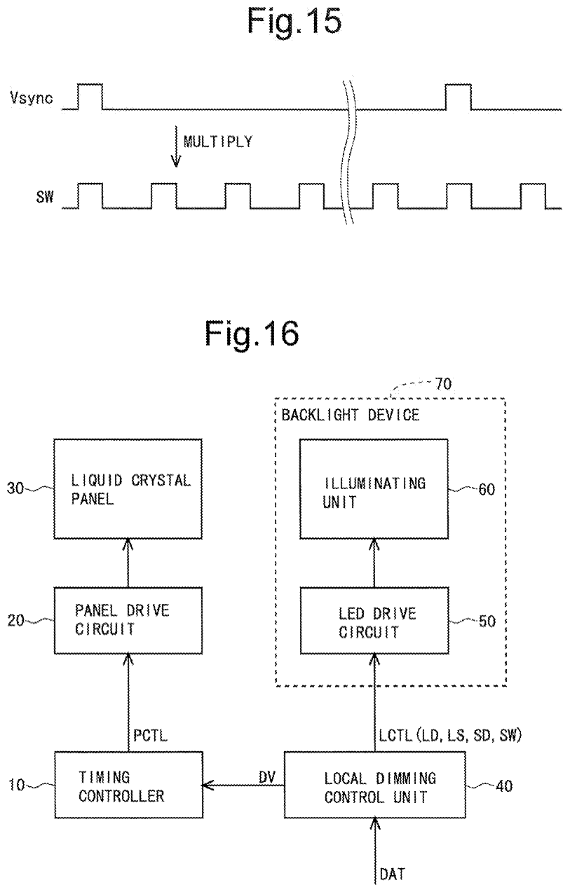

Although a turn-on switching signal SW is generated based on a horizontal synchronizing signal Hsync in the above-described second embodiment, a turn-on switching signal SW can also be generated based on a vertical synchronizing signal Vsync. Specifically, in the present variant, a timer is provided in the switching signal generating unit (see FIG. 14) 560, and a vertical synchronizing signal Vsync is multiplied using the timer as shown in FIG. 15, by which a turn-on switching signal SW is generated. For example, in a case in which the LEDs 61 are divided into four groups and each LED 61 should be turned on four times during each frame period as described above, the timer measures time with a length corresponding to a ( 1/16) frame period. Then, based on that, the switching signal generating unit 560 multiplies a vertical synchronizing signal Vsync such that the frequency is 16×, and thereby generates a turn-on switching signal SW.

### 3. Third Embodiment

### <3.1 Outline and Overall Configuration>

In the above-described first and second embodiments, a turn-on switching signal SW for switching read destination of the turn-on control data LD is generated in the LED drive circuit 50. In contrast, in the present embodiment, a turn-on switching signal SW is provided to the LED drive circuit 50 from an external source. A difference from the first embodiment will be described below.

FIG. 16 is a block diagram showing an overall configuration of a liquid crystal display device according to a third embodiment. In the present embodiment, LED control signals LCTL which are transmitted to the LED drive circuit 50 from the local dimming control unit 40 include turn-on control data LD, a latch signal LS, operation setting data SD, and a turn-on switching signal SW. That is, in the present embodiment, the turn-on switching signal SW is provided to the LED drive circuit 50 from the local dimming control unit 40. Other than that, the present embodiment is the same as the first embodiment. Note that a turn-on switching signal SW may be provided to the LED drive circuit 50 from toe timing controller 10.

### <3.2 Configuration of the LED Drive Circuit>

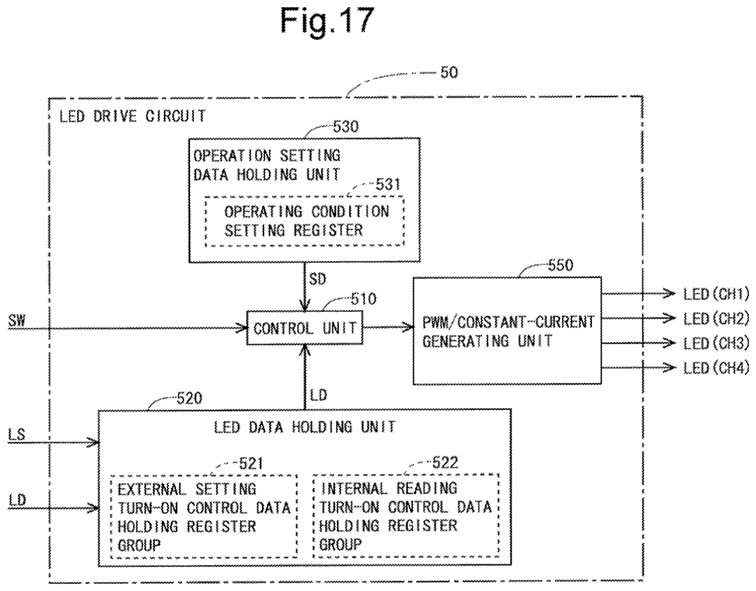

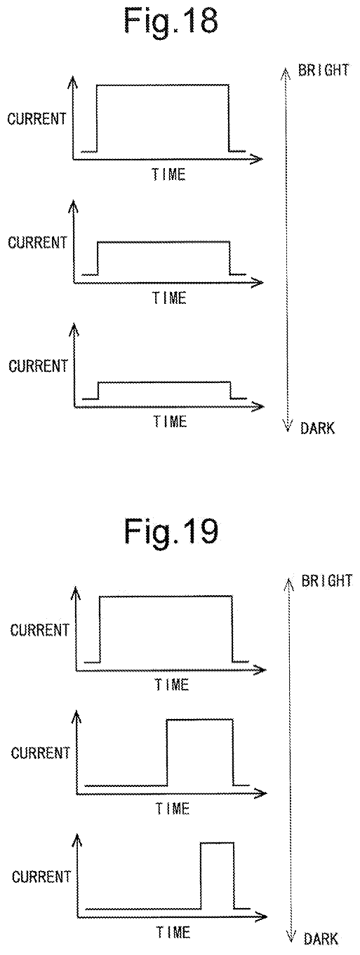

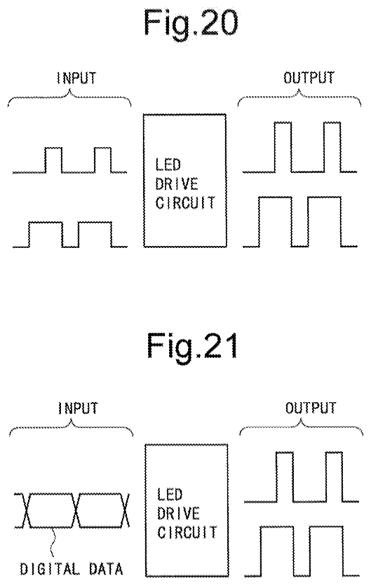

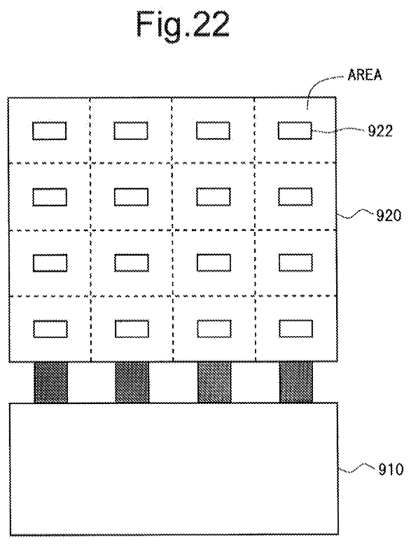

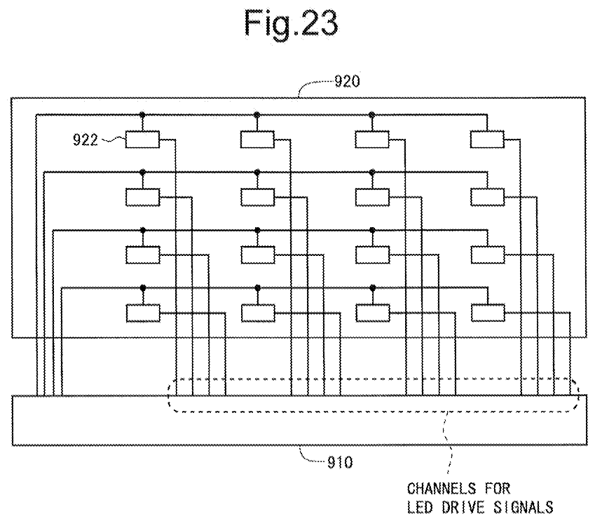

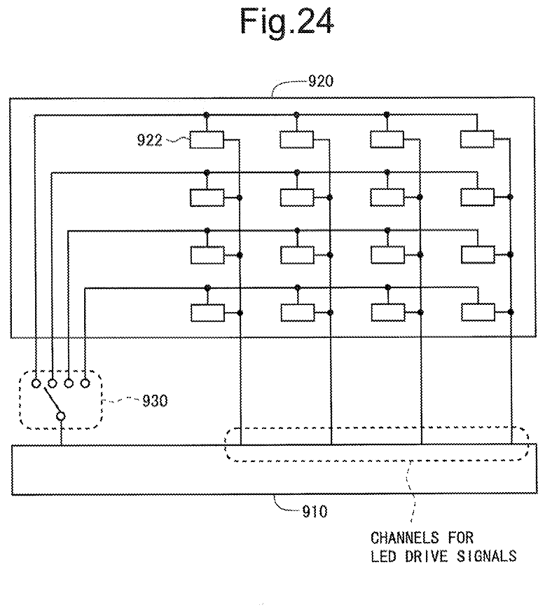

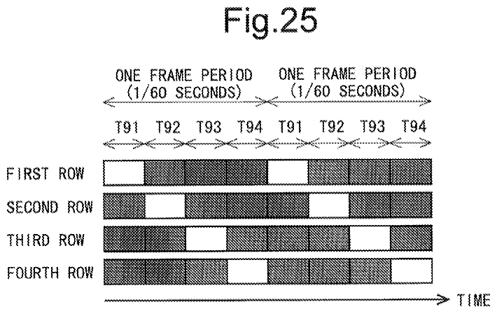

FIG. 17 is a block diagram showing a functional configuration of the LED drive circuit 50 in the present embodiment. In the present embodiment, as shown in FIG. 17, a turn-on switching signal SW which is transmitted from an outside of the LED drive circuit 50 is provided to the control unit 510. Then, based on the turn-on switching signal SW, the control unit 510 reads turn-on control data LD from the internal reading turn-on control data holding register group 522 in the LED data holding unit 520. As such, based on the turn-on switching signal SW transmitted from the outside of the LED drive circuit 50, as in the first embodiment, switching of registers of read destination of the turn-on control data LD used to drive the LEDs 61 is performed.

### <3.3 Advantageous Effects>

Also in the present embodiment, as in the first embodiment, a backlight device that can perform time-division driving of LEDs so as not to cause flicker can be implemented without using a high-speed interface.

### 4. Others

Although one LED is provided in each area in the above-described embodiments, the present invention is not limited thereto. Even when an LED unit including a plurality of LEDs is provided in each area, the present invention can be applied.

Although the present invention is described in detail above, the above description is to be considered in all respects as illustrative and not restrictive. It will be understood that many other changes or modifications may be made without departing from the true spirit and scope of the present invention.

What is claimed is:

1. A backlight device including LEDs as light sources, the backlight device comprising:
a plurality of LED units divided into a plurality of groups, each of the plurality of LED units including one or more LEDs; and
an LED drive circuit configured to time-divisionally drive the LEDs included in the plurality of LED units on a group-by-group basis, wherein
the LED drive circuit:
includes a turn-on control data holding unit configured to hold turn-on control data, the turn-on control data being data transmitted from an external source to control luminances of the one or more LEDs included in each of the plurality of LED units; and
drives a drive-target LED based on turn-on control data read from the turn-on control data holding unit based on a predetermined turn-on switching signal,
the one or more LEDs included in each of the plurality of LED units are driven N times (N is an integer greater than or equal to two) during one frame period, and
turn-on control data corresponding to the one or more LEDs included in each of the plurality of LED units is read by the LED drive circuit N times during one frame period from the turn-on control data holding unit.

2. The backlight device according to claim 1, wherein when a length of one frame period is FT and a number of the groups is GN, turn-on control data read from the turn-on control data holding unit based on the turn-on switching signal is switched every time T calculated by a following equation:
T=FT/(GN×N).

3. The backlight device according to claim 2, wherein the LED drive circuit includes an operating condition information holding unit configured to hold information on the length of one frame period, information on a number of times the one or more LEDs included in each of the plurality of LED units are driven during one frame period, and information on the number of the groups.

4. The backlight device according to claim 1, wherein the LED drive circuit includes a timer configured to generate the turn-on switching signal by measuring time from a driving start time point of LEDs included in each group.

5. The backlight device according to claim 1, wherein the LED drive circuit includes a turn-on switching signal generating unit configured to generate the turn-on switching signal based on a synchronizing signal transmitted from an external source.

6. The backlight device according to claim 5, wherein
the synchronizing signal is a horizontal synchronizing signal, and
the turn-on switching signal generating unit generates the turn-on switching signal by counting a number of times a pulse of the horizontal synchronizing signal is generated.

7. The backlight device according to claim 5, wherein
the synchronizing signal is a vertical synchronizing signal, and
the turn-on switching signal generating unit generates the turn-on switching signal by multiplying a frequency of the vertical synchronizing signal.

8. The backlight device according to claim 1, wherein the turn-on switching signal is provided to the LED drive circuit from an external source.

9. The backlight device according to claim 1, wherein the turn-on control data holding unit is a register.

10. The backlight device according to claim 1, wherein the turn-on control data holding unit is a memory. 11. A display device comprising:
a display panel including a display portion configured to display an image; and
a backlight device according to claim 1, the backlight device being provided on a back of the display panel such that the display portion is irradiated with light.
